(19) United States
(12) Patent Application Publication
(10) Pub. No.: US 2014/0244432 A1
(43) Pub. Date: Aug. 28, 2014

(54) E-Commerce System with Personal Price Points

(71) Applicant: WAL-MART STORES, INC., Bentonville, AR (US)

(72) Inventor: Stephanie M. Middlebrooks, Bentonville, AR (US)

(73) Assignee: WAL-MART STORES, INC., Bentonville, AR (US)

(21) Appl. No.: 13/777,014

(22) Filed: Feb. 26, 2013

(51) Int. Cl. G06Q 30/06

(52) U.S. Cl. CPC G06Q 30/0601
USPC 705/26.8; 705/27.1

(57) ABSTRACT

An ecommerce system is disclosed that uses personal price points (alone or in combination with other buying criteria) to trigger certain automated retail transactions. The system includes a customer interface engineered to allow a customer to either buy merchandise in accordance with retailer-defined selling criteria (including at least an “offered price point”) or to tag merchandise with customer-definable buying criteria (including at least an “acceptable price point”). Computational comparisons of the criteria are executed periodically to determine changes that may occur, for example, with sales, price reductions, and “rollbacks”. If a match or other suitable computed relationship is found, an automated retail transaction—such as the transmission of an electronic notification to a customer's email address or smartphone number—is executed.

### FIELD

The prevent invention is directed, in general, to electronic systems for buying and selling merchandise, and in particular, to an ecommerce system using personal price points to automatically trigger electronic retail transactions.

### BACKGROUND

The buying and selling of merchandise through electronic systems—i.e., “e-commerce”—is currently well accepted and pervasive.

According to recent government statistics, from 2002 to 2010, retail e-sales increased at an average growth rate of 17.9 percent, compared with 2.6% for total retail sales. (See, U.S. Census Bureau E-Stats Report, published May 10, 2012). With U.S. retail e-commerce sales reaching $160 billion in 2010, and unadjusted estimates for 2011, reported at $194.3 billion, e-commerce is unquestionably economically significant and still expanding.

With several retailers and other commercial entities participating in e-commerce activities, price competition has intensified. Flatter pricing models are particularly prevalent in the online retail sales sector, wherein the internet has substantially reduced customer costs for acquiring product information and for purchasing merchandise. Online competitors are numerous. Customers are knowledgeable. Loyalty is fleeting.

One online method currently used to engage retail customers is to offer online subscriptions to electronic alerts and news, thereby promoting customer awareness, attention, and interest in the retailer and/or the retailer's merchandise. In one variation, the customer is electronically alerted whenever a retailer announces a sale, promotion, new product offering, or new product pricing. The subscriber is typically provided with means to select the type of alert received. For example, most (if not all) online retailers allow subscribers to opt out of generic promotional alerts and receive only those alerts related to a particular product or service.

While current customer alert and notification systems continue to provide retail utility, there is growing interest in providing even more advanced systems.

In particular, an argument supporting the use of customer alert systems is that increasing customer awareness leads to increasing sales. In other words, by providing customers with means to improve their awareness and understanding of retail offerings, they are more likely to pursue them.

It has been observed however that when information is generic and of little relevance to a customer, the value of communicating that information will diminish progressively over time. With customer attention lowered in response to a stream of generic information, the occasional transmission of information that is specific and relevant, and that may lead to a sale, can easily be overlooked.

To prevent such missed opportunities, an automated alert system that is specific and relevant—as well as flexible and comparatively easy to implement within an e-commerce framework—is needed.

### SUMMARY

Responding to the above need, an ecommerce system is provided that enables the use of personal price points (alone or in combination with other customer buying criteria), in an ecommerce website or internet application, to trigger the execution of certain automated retail transactions related to the selected items of merchandise.

In particular, a customer interface for the ecommerce system is engineered to allow a customer to either buy merchandise in accordance with retailer-defined selling criteria (including at least an “offered price point”) or to tag merchandise with customer-defined buying criteria (including at least an “acceptable price point”). Computational comparisons are executed periodically to determine whether changes in the criteria occur, for example, as a result of retailer adjustments (cf., prices reductions and sales). If a match or other suitable computed relationship is found, an automated retail transaction is executed, potentially preventing a customer purchasing opportunity otherwise lost to misinformation.

The e-commerce system has variants. For example, the automated retail transaction can be the transmission of an electronic notification to a customer's email address or a smartphone number, and/or can involve an electronic purchase of a selected item of merchandise. Similarly, aside from an ecommerce website, the ecommerce system can also be embodied as internet application (or so-called “web app”) capable of installation and execution on a customer's smart phone, or other mobile digital device. Other variations and alternatives are addressed in the detailed description below.

In light of the above, it is principal object of the invention to provide means for automatically alerting customers to changes in the selling price of selected items of merchandise.

It is another object of the present invention to provide a method for providing personal buying criteria in an electronic system for buying and selling merchandise.

It is another object of the present invention to provide a method for executing an automated retail transaction as a function of customer-inputted buying criteria.

It is another object of the invention to provide ecommerce websites and internet applications that enable a customer to receive automated alerts relating to selected items of merchandise based on customer-inputted buying criteria.

It is another object of the invention to provide ecommerce websites and internet applications that enable a customer to receive automated alerts relating to selected items of merchandise based on customer-inputted “personal price points”.

For a further understanding of the nature and objects of the invention, reference should be had to the following description taken in conjunction with the accompanying drawings.

### BRIEF DESCRIPTION OF THE DRAWINGS

FIGS. 1A, 1B, and 1C illustrate schematically certain components of a computer network 10 arranged to host a ecommerce website, the ecommerce website using customer and retailer buying and selling criteria 32 and 22 for executing automated retail transactions (e.g., the transmission of alert 40).

FIG. 2A illustrates schematically certain components of a customer interface 130 used on an ecommerce retail website according to an embodiment of the invention.

FIG. 2B illustrates an example of an automated electronic alert 240, received on a customer smartphone 230, triggered according to an embodiment of the invention.

FIG. 3 is an entity relationship diagram 80 for a basic relational database, illustrative of a design useful for tracking buying and selling price points and like criteria.

### DETAILED DESCRIPTION

The present invention is directed to an electronic retailer-operated system wherein the input of a “personal price point”, alone or in combination with other customer buying criteria, provides a foundation for processes that result, directly or indirectly, in the execution of an automated retail transaction, such as an electronic alert and/or an electronic purchase.

In a principal embodiment, the system includes a customer interface that enables a customer to either (a) buy merchandise in accordance with retailer-defined selling criteria comprising at least an “offered price point” or (b) tag merchandise with customer-definable buying criteria comprising at least an “acceptable price point”. The selling criteria and the buying criteria are expected to differ initially. Computational comparisons are thus executed periodically to determine changes that may occur, for example, with sales, price reductions, and “rollbacks”. If a match or other suitable computed relationship is found, an automated electronic notification is sent to a customer's email address or smartphone number.

Other automated retail transactions, aside from electronic notifications, are supported. In certain embodiments, an automated electronic purchase of customer-selected merchandise is also a function of the computational comparison of buying and selling criteria. In particular, a customer electronically pre-authorizes the purchase of a selected item of merchandise (e.g., contemporaneously with the input of a personal price point), and provides customer purchasing information (i.e., contemporaneously or in a prior transaction). Upon suitable correlation of customer and retailer criteria, the item is automatically purchased using the customer's purchasing information.

In certain embodiments, the invention is structured as an online retail website with a wishlist facility that enables a customer, using the customer interface, to record in association with a customer account a list of merchandise desired for future purchase and/or further consideration. Merchandise within (or to be included in) this wishlist is tagged with customer-defined buying criteria, thereby prompting an automated electronic alert and/or electronic purchase when met.

In another embodiment, the invention is structured as a internet application installable, for example, on a customer smartphone. The internet application comprises a customer interface (functionally similar to that employed for an e-commerce website) and means for engaging, interacting, and communicating with the retailer's e-commerce facility to effect periodic computational comparisons of buying and selling criteria and triggering electronic alerts and/or purchases.

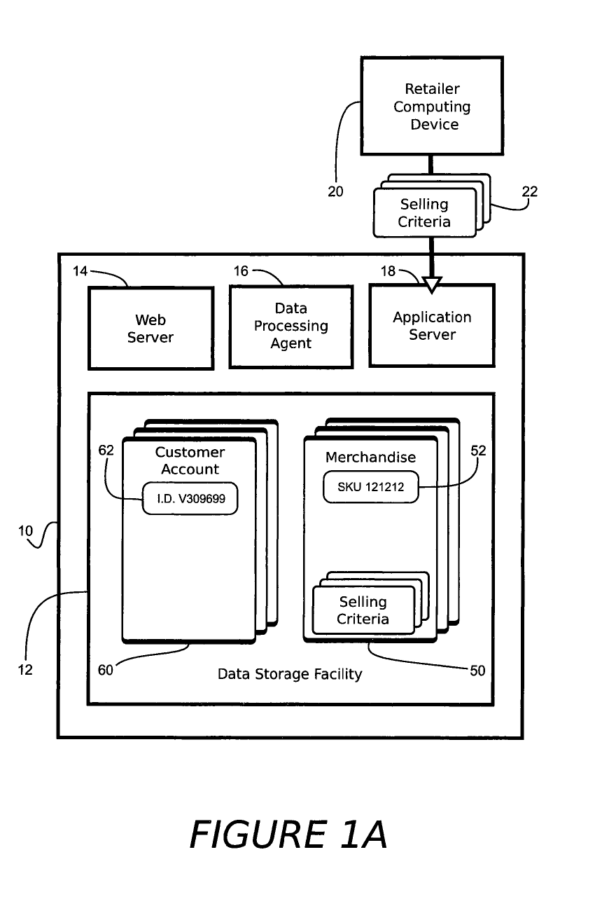

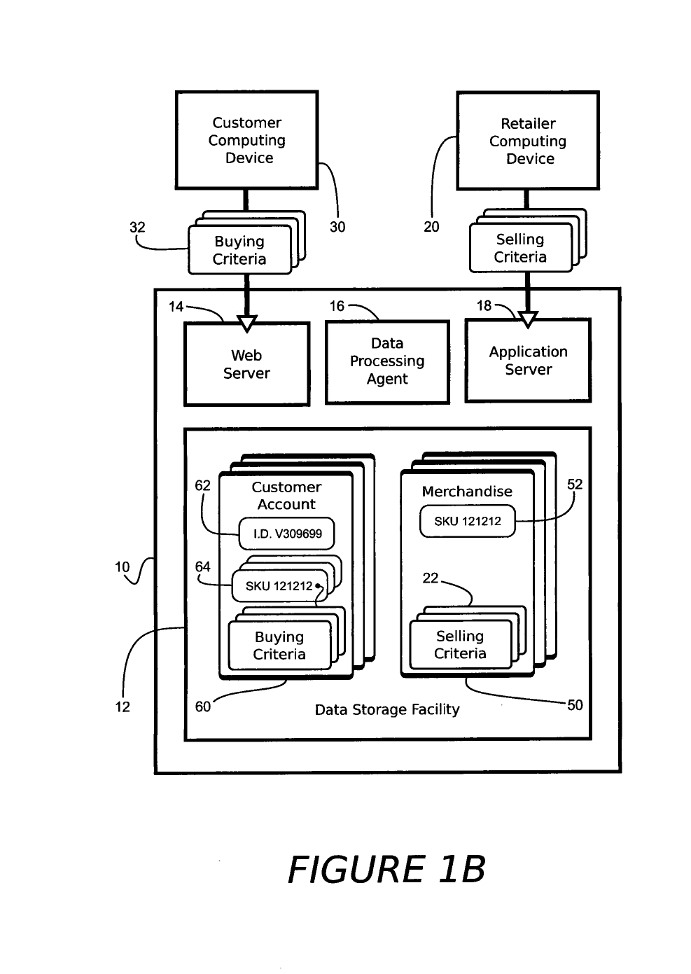

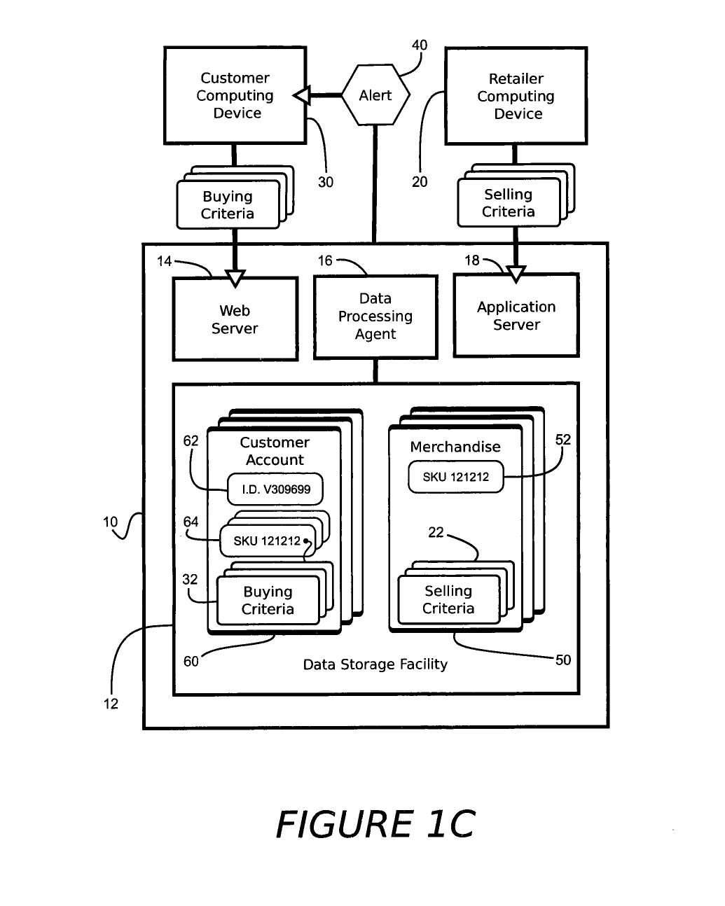

FIG. 1A illustrates schematically certain components of a retailer-operated computer network 10, useful for hosting an ecommerce website structured in accordance with the invention.

As shown, computer network 10 comprises a data storage facility 12, a data processing agent 16, a web server 14, and an application server 14. Data storage facility 12 is used to store data relating to customer accounts 60, merchandise 50, and any buying and selling criteria associated therewith. Data processing agent 16 is used for computational comparisons. Application server 18 is used by the retailer for inputting selling criteria. Web server 14 is used for publishing (to customers) an ecommerce website that incorporates the personal price point features of the invention.

The e-commerce website, published through web server 14, is accessed at a URL address, using an internet browser or other suitable web interface, through a personal computing device 30, such as a smart phone, tablet, or personal computer. The website provides a means for a retailer to sell merchandise to customers, wherein buying and selling is consummated electronically through a “virtual storefront”. Transactions initiated on this virtual storefront are executed through resources within the retailer's computing network 10, and fulfilled through “back office” integration, shipping, and fulfillment facilities, also operated, managed, and/or directed by the retailer.

Programming for the e-commerce website includes HTML, alone or in combination with other internet programming and scripting languages, preferably providing feature-rich functionality, such as dynamic data interchange, presentation, and management; cross browser/device compatibility, and appropriate online safeguards and security. Other programming and scripting languages include PHP, Javascript, JQuery, XML, Ajax, and Java. CSS can be used, for example, to provide good cross browser/device compatibility.

The computing resources for the website need not be contained in one central logical or physical location. As known to those skilled in the art, the technical resources can be distributed throughout a network. For example, presentation can be achieved using a web application executing on a web server, sharing data with remote data storage facilities, and protected by security devices running on the network edge. For global retailers, the network and facilities can be massive. For smaller retailers, the supporting computing resources can be more modest, potentially comprising—albeit extreme—a single personal computer with internet access.

The website is preferably also provided with intuitive navigation tools, comprehensive merchandise descriptions and images, flexible product searching capabilities, electronic forms enabling various payment methodologies, information related to purchasing and shipping policies, contact information, and promotional and marketing collateral for the site and its merchandise.

The website can be operated, managed, or otherwise directed by non-traditional retailers (i.e., entities that primarily provide non-retail related services, but nonetheless sell merchandise to end users). For example, to complement existing sales channels, a manufacturer (e.g., an OEM) may initiate direct-to-customer sales through a virtual storefront added to a website that had otherwise been previously used only to provide news and public information. Similarly, a non-manufacturing organization (e.g., sports organization or entertainment venue) may incorporate a virtual storefront to their web site to sell products that are either related to that organization or of interest to members of that organizations (e.g., branded products, tickets, and souvenirs).

As shown in FIG. 1A, selling criteria 22 is entered by a retailer using a computer 20 logged into network 10, for example, through an application server 22. As used herein, the term “selling criteria” shall be construed to include any terms, limitations, or requirements set by a retailer for selling merchandise.

Although the principal selling criteria is “price”, it is not necessarily the only selling criteria. Others include, but are not limited to, “quantity”, “location”, and “date”.

In respect of “quantity”, a retailer can place limits on the number of merchandise offered for sale for several reasons. For example, a quantity limitation may simply reflect inventory, which is finite. Even if not limited by supply, quantity may be limited (minimum or maximum orders) as result of a contractual arrangement with a supplier or to accommodate a marketing model for a particular item of merchandise.

In respect of “location”, a retailer may need to impose limits on where particular items are sold, such as particular stores, regions, and states. Rationales for location-based limitation include, for example, supply and distribution chain factors, legal and regulatory restrictions, contractual arrangements, and marketing strategies.

In respect of “date”, a date limitation can be imposed when merchandise is not available until a particular date. This typically occurs for merchandise that is pre-marketed or pre-advertised prior to availability, such as common in media or event related merchandise. In contrast to pre-ordering functions provided currently on several published online retail websites, the “date” criteria—when used in the present invention—is used in combination with a “price” criteria.

Despite possible inclusion of other selling criteria, in all embodiments of the present invention, “price” is always a selling criteria. In practice, exceptions are expected, such as those resulting from entry errors and website posting and maintenance schedules. Regardless, for essentially all items of merchandise offered for sale on the ecommerce website, an “offered price point” is established.

As used herein, “offered price point” shall be defined as the price at which merchandise is offered for sale and which, when accepted buy a customer, leads to consummation of that sale without further negotiation. In the context of the present invention, once computational comparison finds an appropriate match on price, the invention proceeds towards its automated electronic alert and/or purchasing procedures.

A computer network used by the retailer to host the ecommerce website can comprise a plurality of interconnected computers and terminals, servers, data storage facilities, hubs, routers, switches, network security devices, network management devices, wireless nodes and access points, load balancers, and related software. Within this network, data relating to customer accounts and merchandise is stored within the network's data storage facilities, with web serving facilities publishing the ecommerce website, which draws upon, interacts with, and provides access to such data.

The data storage facilities can comprise one or more data storage devices capable of recording and retrieving digital information from a medium (e.g., magnetic, optical, semiconductor, etc.). For small to medium-scale retailers, the data storage facilities can utilize storage with comparatively modest capacity, such as provided by a single internal or external hard drive or flash drive. For large global retailers, the data storage facilities will require greater capacity and bandwidth, and thus, may employ several networked and attached electronic data storage components, these being deployed at an enterprise-scale and may include, for example, arrays of data servers and file servers; SAN and NAS storage facilities; RAID storage systems, data backup, archiving, and redundancy facilities; and data management and load balancing agents.

Customer account and merchandise related data can be stored and retrieved from the data storage facilities utilizing well known database technologies. Examples of data management tools for small to medium-sized retailers include consumer-grade software packages such as Microsoft Access, dBase, Filemaker Pro, and OpenOffice Base. For large global retailers, internal and external database design, development, and management can implement any of the various DBMS and models currently available based on SQL, NoSQL, MySQL, XML, OQL, and like database programming languages.

The input of customer-definable buying criteria 32 is accomplished using a customer interface, such as that provided on an ecommerce website. As shown schematically in FIG. 1B, the ecommerce website can be published from a retailer's computing network 10 through the use of a web server 14. Access into website by a customer can be accomplished with a personal computer or like computing device 20 equipped with a suitable internet browser.

The preferred customer interface includes all element of the ecommerce website used by a customer to interact with the website, for the purpose of gathering and submitting information and data from and to the retailer's computing network in relation to the buying and selling of merchandise. The customer interface can include, for example, pointers, cursors, radio buttons, icons, hyperlinks, menus, tables, lists, check boxes, input fields, line interfaces, images, scroll bars, bookmarks, sliders, toggle switches, popup notes, dropdown calendars, wheels, and dials. Customer input can be accomplished through a keyboard (e.g., a physical keyboard on a laptop computer or a dropdown keyboard on a smartphone application), a pointing device (e.g., a mouse), touch (e.g., on a touch-sensitive capacitive screen), stylus (e.g., on a pressure-sensitive resistive screen), and/or though other input sensing devices (e.g., magnetic stripe readers, optical scanners, and voice scanners).

Despite variability, the customer interface is in all instances of invention provided with means for performing a series of three basic steps. First, means are included to enable a customer to obtain information about an item of merchandise. Second, once the information is obtained, confirming that the item does exist for possible sale, means associated with the customer interface enable the customer to “tag” or otherwise “set aside” that item, i.e., an item that the customer wishes the retailer to act upon when certain criteria are met. And third, once tagged, means associated with the customer interface enable a customer to define certain buying criteria for the selected item. In sum, the customer interface has embodied therein or associated therewith (1) means for browsing items, (2) means for selecting items, and (3) means for setting criteria for selected items.

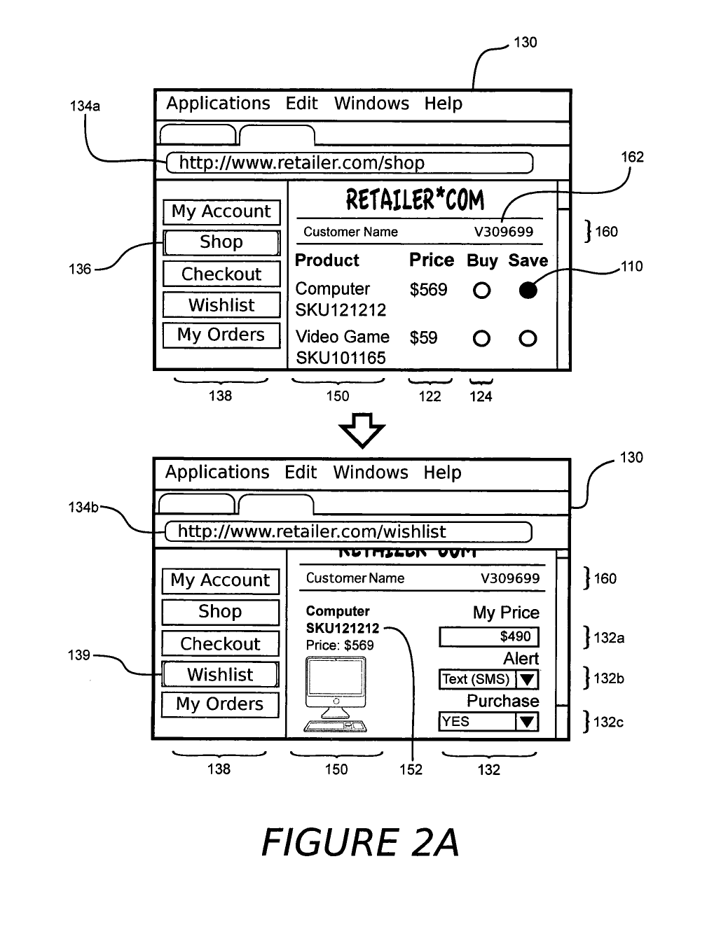

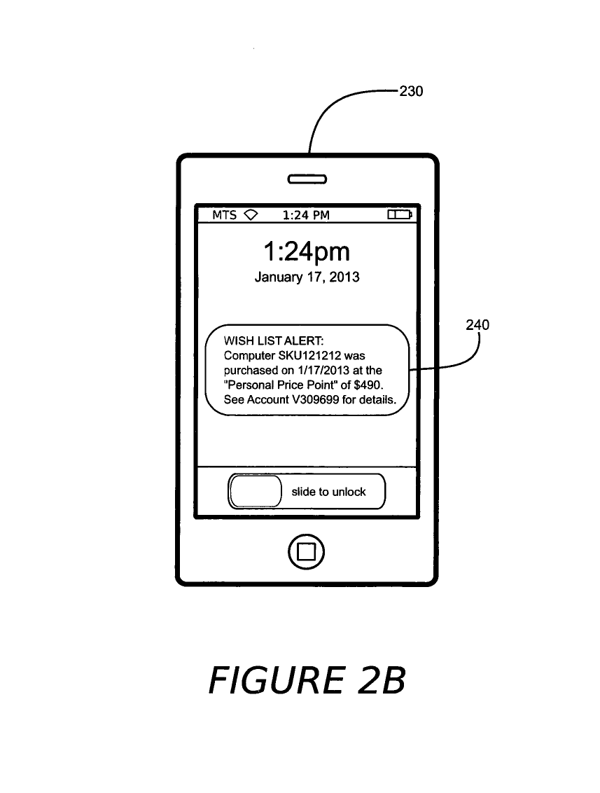

FIG. 2A illustrates a representative customer interface for a hypothetical ecommerce website 130 entitled “Retailer*Com”, which is accessible to customers through the hypothetical URL address<http:/www.retailer.com>.

The customer interface of the ecommerce website 130 includes navigation buttons, which enable a customer to access and browse the website's content. Among the navigation buttons 138 is a button 136 labeled “Shop”, which links to a dashboard 134a for buying merchandise. As shown, the shopping dashboard is coded to sell (cf., radio buttons 124 labeled “Buy”) a selection of merchandise 150 (including “Computer SKU 121212”) at retailer-defined offered price points 122.

In addition to means for buying merchandise, the customer interface for the ecommerce website 130a also has means for saving particular items onto a wishlist associated with a customer's individual account 162. As shown, radio button 110 labeled “Save” effects directly or indirectly the “tagging” of a selected item (e.g., “Computer SKU 121212), resulting in the placement thereof onto the customer's “wishlist”. Clicking radio button 110, if desired, can be engineered to automatically navigate into the item's specific listing within the customer's wishlist 134b. Alternatively, navigation into the wishlist dashboard 134b can be achieved by clicking navigation button 139 labeled “Wishlist”.

Within the wishlist dashboard 134b, the tagged item 152 (i.e., the “Computer”) is displayed together with its product identification number 152 (i.e., SKU 121212) and its offered price point (i.e., $569). The customer interface for the dashboard 134b, as shown, includes customer input means 132 comprising means for entering a personal price point (i.e., field 132a labeled “My Price” and having an input value of $490); means for selecting a preferred form for alerts (i.e., drop down menu 132b labeled “Alert” and having a selected value of “Text (SMS)”); and means for authorizing electronic payment (i.e., drop down menu 132c labeled “Purchase” and having a selected value of “YES”). Other alternative selectable values (not illustrated) for “Alert” menu 132b and “Purchase” menu 132c can include, for example, “Email” or “NO”, respectively.

FIG. 2B provides an illustration of a representative “alert” triggered by a personal price point, such as that illustrated in FIG. 2A.

In particular, once a personal price point is set for an item of merchandise, computational comparisons are conducted periodically to determine if a suitable match exists between the retailer's and customer's selling and buying criteria. For example, if a retailer decides to re-price the selected item 150 (i.e., “Computer SKU 121212”) in wishlist dashboard 134b previously tagged by customer 160 (i.e., customer I.D. No. “V309699”) from an offered price point of $569 to an offered price point of $490, in accordance with the present invention, an alert 240 is transmitted as a text message to a customer smart phone 230.

As shown, the customer alert 240 provides information identifying the item of merchandise (i.e., “Computer SKU 121212”), the account (i.e., customer I.D. no. “V309699”), the date (i.e., “Jan. 17, 2013”), the buying criteria (i.e., “′Personal Price Point′ of $490”), and the action taken (i.e., “purchased”).

Although the present invention does not require automated purchase, for purposes of illustration, alert 240 in FIG. 2B signifies consummation of such purchase for consistency with the authorization 132c exemplified in FIG. 2A. When automated purchase is not requested, the alert may simply indicate, for example, that the “Personal Price Point” was “met”.

In respect of “tagging” merchandise, any methodology or instrumentality enabling a customer to select a particular item of merchandise from the retailer's online inventory of salable merchandise is within the scope of the invention.

“Tagging” can be accomplished by providing tags, tokens, labels, flags, indicators, fields and/or the like within the data record for the item of merchandise, for example, in a flat file database stored within the data storage facility of the retailer's computer network. Alternatively, “tagging” can be supported by encoding appropriate parent-child relationships among the ecommerce-related data tables of a relational database. Such relational database structures are preferred for complex ecommerce systems, offering comparatively better flexibility, modularity, and efficiency in the creation, presentation, reporting, searching, manipulation, and sorting of ecommerce related data. Other methods of tagging, marking, flagging, or otherwise differentiating specific items from a collection thereof are available to those skilled in the art in light of the present disclosure.

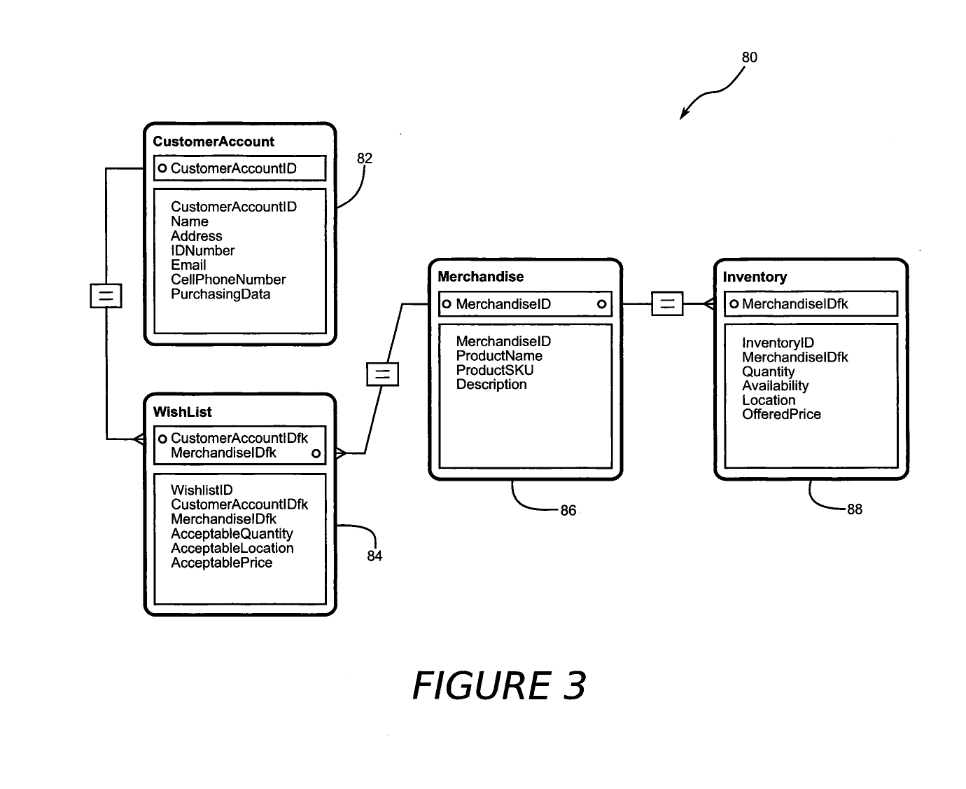

An example of an ecommerce-related relational database in illustrated in FIG. 3, which depicts in particular an entity relationship diagram (ERD) 80 for a relational database comprising a “CustomerAccount” table 82, a “WishList” table 84, a “Merchandise” table 86, and an “Inventory” table 58.

The “Merchandise” table 86 is used for data relating to a particular item of merchandise (e.g., name, serial number, and description). The “Inventory” table 88 is used for data relating to a retailer's stock of merchandise (e.g., quantity, availability, location, and price). The “CustomerAccount” table 82 is used for data relating a particular customer (e.g., name, address, account number, contact details, and purchasing information). The “WishList” table 84 is used for data relating to a customer's wish list (e.g., selected items of merchandise and buying criteria). As is known in the field of database design, relationships between these tables are established using so-called “primary keys” (cf., “CustomerAccountID”, WishlistID”, “MerchandiseID”, and “InventoryID”) and so-called “foreign keys” (cf., “CustomerAccountIDfk” and “MerchandiseIDfk”).

In respect of “tagging”, an ecommerce website with access to a relational database, structured in a manner similar to the ERD of FIG. 3, would be suitably enabled for: selecting merchandise (cf., retrieving data from the related “Inventory” and “Merchandise” tables 86 and 88); creating a wishlist record linked to a customer account (cf., creating and retrieving data from the related “CustomerAccount” and “WishList” tables 82 and 84), and populating buying criteria fields within the “WishList” table 84.

The term “buying criteria”—as construed herein—includes any terms set by a customer for either (a) buying merchandise or (b) generating interest towards potentially buying merchandise. The setting of the “buying criteria” does not require a customer to consummate a purchase, or otherwise create any actual commitment to consider, reconsider, or proceed in any manner with respect to a flagged item of merchandise. The act of differentiating merchandise per se is sufficient indicia of that customer's interest in the item offered for sale.

As with the “retailer-definable selling criteria”, the principal “customer-definable buying criteria” is “price”. Other buying criteria nonetheless includes, but is not limited to “quantity”, “location”, and “shipping and delivery preferences”.

In respect of “quantity”, the means for setting buying criteria can include the triggering of notices or automated purchases, for example, when a previously unavailable item (cf., retailer quantity=0) becomes available (cf., retailer quantity>0), or when a previously “limited quantity” item becomes “unlimited” or adjusted to a new lower limit, provided matching price criteria is also present.

In respect of “location”, a customer may wish to purchase items only at a specific store, or within a specific region, or within a specifiable radius from a specifiable location. This criteria is particularly useful for traditional retail store shopping. The ability to trigger alert notices as a function also of location-related buying criteria can facilitate travel planning of customer shopping activities.

In respect of “shipping and delivery preference”, the mean for setting buying criteria can include the triggering of notices or automated purchases as a function also of, for example, whether shipping and/or delivery is free, expedited, discounted, guaranteed, etc. Such buying criteria would be particularly useful for on-line purchases.

Despite other buying criteria, in all embodiments of the present invention, “price” is always included within the “customer-defined buying criteria”.

Given the importance of a customer's personal price points, restriction and/or filters are preferably imposed on the value inputted by a customer, for example, by utilizing data handling and validation protocols and algorithms well known in the field of web design. Typical validations would include checks for appropriate numerical format and checks to determine whether an inputted value falls within acceptable range. For embodiments where computational comparisons would only potentially trigger the transmission of an alert, attention and resources employed to validate inputs can be relaxed to the extent that use and/or acceptance of erroneous data would engender comparatively less risk. Tight validation protocols, however, are desirable when automated purchasing is involved, for example, to prevent triggering a purchase based on computational comparisons tainted or corrupted by faulty data input, or to prevent a customer from unintentionally mistyping a higher price potentially triggering an unwanted automated purchase.

The personal price points, as well as other customer-definable buying criteria, can have associated therewith a retailer or customer definable expiration date, beyond which the criteria will no longer be considered. A customer may utilize such feature, for example, to prevent automated purchasing of an item beyond a relevant date (cf., a holiday, birthday, or anniversary). A retailer may also find such feature useful, for example, to manage network resources, bandwidth, and data integrity.

As mentioned, with buying and selling criteria stored within a retailer's network, computational comparisons are executed periodically to determine whether further action on a tagged item of merchandise is merited.

As shown in FIG. 1C, computational comparison is effected by a data processing agent 16 installed and operating within the retailer's computer network 10. Data processing agent 16 is arranged in communication with the network's data storage facility 12, such that it has access to both customer account data 60 (thereby providing access also to items of merchandise 64 tagged with customer 62's buying criteria 32) and the retailer's merchandise data 50 (thereby providing access also to the retailer's selling criteria 22 for particular items of merchandise 52). Data processing agent 12 retrieves relevant data from the customer account 60 and merchandise data 50 and performs the computational comparisons that, if merited, ultimately lead to an automated alert 40 and/or the purchase of the item of merchandise 52.

As is known in the art, the data processing agent 16 can comprise well-known hardware and software components, consolidated in a single central location or device, or distributed over several devices and/or locations, real or virtual, within the administrative control of the retailer or the retailer's agent. Mathematical functionality of a data processing agent 16 can be engineered for execution, partially or completely, on a client-side internet browser or web application. Due to resource and control limitations on client-side devices, such embodiments are at present felt more appropriate for modest deployments. For deployment at an enterprise-scale, the data processing agent 16 is preferably executed completely or substantially within the administrative jurisdiction of the retailer's computing network.

The frequency of computation is subject to variation. Retailers that deal in small and narrow inventories and/or merchandise with stable price points may not need to compute as frequently as a retailer dealing with diverse and fluid inventories subject to persistent price and demand fluctuations. In one mode of practice, calculations can be manually commenced (cf., clicking a “submit” button) after a retailer adjusts prices or quantities. Although labor intensive, this option has the advantage of potentially providing better retailer control. Another possibility would be to commence calculations based on a particular schedule (e.g., weekly, daily, hourly, etc.). In this regard, more frequent calculation could lead to faster product turnover.

The types of computational calculation depend on the data types involved in the buying and selling criteria. When only price is involved, the calculation is preferably a mathematical calculation, such as subtracting the retailer's offered price point value from the customer's acceptable price point value, such that the absence of a difference (or a negative difference) triggers an automated retail transaction on the tagged item of merchandise.

Given the possibility that other criteria are involved, as well as different forms of data input (i.e., integers, floating point real values, alphanumeric strings, boolean, etc.), the term “computational comparison” should not be construed as limited to any particular calculation, algorithm, or mathematical process, but rather should viewed with an eye towards functionality. Regardless of the calculation, algorithm, or mathematical process employed, “computational comparison” decides whether action is taken on customer-tagged merchandise. In other words, the automated retailer transaction is a function of, and relies upon, directly or indirectly, computer-executed processing of the retailer and customer selling and buying criteria.

As shown in FIG. 1C, an electronic notification 40 is transmitted from or otherwise effected by the retailer's computing network 10 to the customer's computing device 30 as a function of the computational comparisons performed by the data processing agent 16.

The electronic alert 40 includes any information capable of indicating, signifying, or conveying to the customer a result of a computational comparison of the customer's buying criteria and the retailer's selling criteria. The electronic alert 40 can be provided in the form of general or specific text-based information, image-based information (e.g., a distinctive pop-up graphical icon or image), or audio-based information (e.g., an automated voicemail message, a distinctive ring tone, etc.)

The preferred electronic alert 40 is an email message, for example, sent from an email facility (not illustrated) provided on the retailer's computer network 10 to a customer's email account hosted by a third party provider (e.g., an internet service provider, social networking site, or free email provider). Addressing information for the email transmission can be provided by the customer within profile data in the customer's personal account 60.

Similarly preferred, the electronic alert can be a text message, for example, sent from an SMS (“Short Message Service”) facility (not illustrated) hosted on the retailer's computer network 10 to a customer's cell phone, hosted by a third-party telecommunication carrier. By using known email-to-sms gateway technologies, an alert in the form of an email message can be sent through SMS communication protocols. The cell phone number for the text message can also be provided by the customer within the customer's profile data.

As mentioned, the action taken upon a tagged item of merchandise as a result of a computational comparison is not limited to the transmission of an electronic alert 40. In certain embodiments, computational comparison triggers an automated electronic purchase.

In one mode of practice, the automated electronic purchase feature—as is the case also with the automated electronic alert feature—is presented within a broader online shopping utility of an ecommerce website as an independent standalone feature, having its own dedicated dashboard and user interface.

Conciseness, clarity, and organization can be advanced however by integrating, combining, or associating the automated purchase feature within an ecommerce listing facility, such as a “wish list” or “watch list”. In many instances, such wish list facilities may already be provided on a pre-existing ecommerce website, and integration of the present invention, may involve only comparatively modest modifications thereto.

Integration can produce relatively seamless results and can avoid or otherwise reduce the need for potentially redundant website utilities, functions, and/or dashboards. By organizing the inventive system within a consolidated wishlist tool, customer attention is focused and engaged. Unnecessary distractions and diversions are avoided.

The wishlist facility—whether pre-existing or not—should be configured to enable a customer using a suitable customer interface to record a list of merchandise in association with the customer registered personal account. As is common practice, wish lists essentially comprise items that customers do not wish to purchase at a particular time, but wish to consider for possible future purchase, or more fundamentally, for purposes only of monitoring and tracking.

For embodiments enabling automated purchases, the input means for the wishlist facility is engineered to enable customers at a minimum: (1) to tag merchandise with customer buying criteria; and (2) to provide customer purchase pre-authorization (i.e., as exemplified in FIG. 2A discussed hereinabove). Means are also preferably included for recording in association with the customer's registered personal account other relevant customer profile and purchasing information (e.g., customer name, identification number, shipping and billing addresses, credit card and bank information, etc.).

In accordance with the invention, electronic purchasing of tagged merchandise, using information and resources shared with and/or otherwise accessible to the wish list facility, is a function of both the customer purchase authorization and computational comparison of stored buying and selling criteria. When triggered, the automated electronic purchase is executed utilizing the customer purchase information in the wishlist-accessible customer account.

As an alternative to an ecommerce website, the invention can also be embodied as a web or internet application installable and executable, for example, on a smartphone, internet-enabled tablet, or other mobile personal digital device. Many of the same back-end computing resources used for an ecommerce website (e.g., data storage facilities, web servers, databases, data processing agents, etc.) can be used for or shared with the web application, with front-end resources (e.g., customer interfaces, dashboards, authentication, etc.) engineered specifically for the mobile personal digital device.

In a preferred embodiment, an e-commerce internet application is provided comprising: a customer interface enabling a customer to both buy merchandise and tag merchandise with customer-definable buying criteria that includes at least an acceptable price point; means for recording the customer-definable buying criteria at the data storage facility; means for executing periodically a computational comparison of the retailer-definable selling criteria and the customer-definable buying criteria; and means for transmitting an alert to the customer as a function of said computational comparison.

It is not required that recording, computing, and transmitting means of the “internet app” be installed and/or executable completely on the mobile personal digital device. For example, the “means for executing a computational comparison” may comprise only a few lines of code in the application that relate to the submission of customer buying criteria, which when executed, ultimately leads to the performance of said computational comparison within the back-end resources available to the internet application.

Similarly, in respect of the “means for transmitting an alert”, the internet application may comprise only a few lines of code relating to and/or effecting the selection and submission of certain alert parameters to the retailer's back-end resources that ultimately are directly responsible for transmitting the alert.

As stated hereinabove, the alert can be sent to any customer proscribed email address or cell phone number. In an embodiment of the internet application, the alert is transmitted back to the device on which the application is hosted, using digital addressing information culled from the device by the internet application during installation and/or as a result of customer use.

Although several embodiments of the invention are disclosed hereinabove, those skilled in the art having the benefits of this disclosure can effect modifications thereto. These modifications are to be construed as being encompassed within the scope of the present invention as set forth in the appended claims.

1. A method for using personal buying criteria in a retailer-operated e-commerce website, the e-commerce website coded to sell merchandise according to retailer-definable selling criteria, the selling criteria comprising at least an offered price point, the method comprising the steps of:
recording the retailer-definable selling criteria at a data storage facility;
providing a customer interface on said website enabling a customer to buy said merchandise at the offered price point, the customer interface also enabling the customer to tag merchandise with customer-definable buying criteria, the buying criteria comprising at least an acceptable price point;
recording the customer-definable buying criteria at the data storage facility;
executing periodically a computational comparison of the retailer-definable selling criteria and the customer-definable buying criteria; and
transmitting an alert to the customer as a function of said computational comparison.

2. The method of claim 1, wherein:
the e-commerce website further comprises a wishlist facility, the wishlist facility enabling said customer using the customer interface to record in association with a customer account a list of said merchandise;
the customer account is hosted on the data storage facility;
the customer-definable buying criteria is associated with the customer account; and
the tagged merchandise is recorded in the list of said merchandise.

3. The method of claim 1, wherein:
the alert is transmitted to the customer as a result of a determination by the computational comparison that the offered price point is equal to or less than the acceptable price point.

4. The method of claim 1, wherein:
the retailer-definable selling criteria includes selling location; and
the customer-definable buying criteria includes buying location.

5. The method of claim 1, wherein:
the retailer-definable selling criteria includes merchandise availability information; and
the customer-definable selling criteria includes merchandise quantity information.

6. The method of claim 2, wherein:
the customer account includes a customer name, a customer identification number, and customer purchasing information.

7. The method of claim 6, wherein:
the customer interface enables the customer to tag merchandise with a customer purchase authorization; and
further comprising the step of:
executing an electronic purchase of tagged merchandise as a function of both (a) the customer purchase authorization and (b) the computational comparison of the retailer-definable selling criteria and the customer-definable buying criteria, the electronic purchase executed utilizing the customer purchase information in the customer account.

8. The method of claim 6, wherein:
the customer account further includes a customer cell phone number; and
the alert transmitted to said customer is a text message sent to the customer cell phone number.

9. The method of claim 6, wherein:
the customer account further includes a customer email address; and
the alert transmitted to said customer is an email message sent to the customer email address.

10. An e-commerce internet application for selling merchandise according to retailer-definable selling criteria, the selling criteria comprising at least an offered price point, the e-commerce internet application comprising:
a customer interface capable of enabling a customer to buy said merchandise at the offered price point, the customer interface also enabling the customer to tag merchandise with customer-definable buying criteria, the buying criteria comprising at least an acceptable price point;
means for recording the customer-definable buying criteria at a data storage facility;
means for executing periodically a computational comparison of the retailer-definable selling criteria and the customer-definable buying criteria; and
means for transmitting an alert to the customer as a function of said computational comparison.

11. The e-commerce internet application of claim 10, wherein the internet application is a website accessible publicly at a URL (uniform address locator) address utilizing HTTP (hypertext transfer protocol).

12. The e-commerce internet application of claim 10, wherein the internet application is a smartphone application capable of being installed and executed on a customer smartphone.

13. The e-commerce internet application of claim 12, wherein said alert is sent to the customer smartphone.

14. The e-commerce internet application of claim 10, further comprising a wishlist facility, the wishlist facility enabling said customer using the customer interface to record in association with a customer account a list of said merchandise, and wherein:
the customer account is hosted on the data storage facility;
the customer-definable buying criteria is associated with the customer account; and
the tagged merchandise is recorded in the list of said merchandise.

15. The e-commerce internet application of claim 14, wherein:
the customer account includes a customer name, a customer identification number, and customer purchasing information.

16. The e-commerce internet application of claim 15, wherein:
the customer interface enables the customer to tag merchandise with a customer purchase authorization; and
further comprising:
means for executing an electronic purchase of tagged merchandise as a function of both the customer purchase authorization and the computational comparison of the retailer-definable selling criteria and the customer-definable buying criteria, the electronic purchase executed for said customer utilizing the customer purchase information in the customer account.
